(19) United States
(12) Patent Application Publication
(10) Pub. No.: US 2010/0277031 A1
(43) Pub. Date: Nov. 4, 2010

(54) METHOD FOR PRODUCING A STATOR HOUSING UNIT

(75) Inventors: Jorg Nelges, Mosbach (DE); Thomas Gilke, Korntal-Munchingen (DE)

Correspondence Address: Driggs, Hogg, Daugherty & Del Zoppo Co., L.P.A., 38500 CHARDON ROAD, DEPT. ABB, WILLOUGHBY HILLS, OH, 44094, US

(73) Assignee: ABB Technology AG

(21) Appl. No.: 12/746,668

(22) PCT Filed: Dec. 5, 2008
(86) PCT No.: PCT/EP2008/010293

§ 371 Date: Jun. 7, 2010

(30) Foreign Application Priority Data
Dec. 15, 2007 (DE) 102007060654.2

(51) Int. Cl. H02K 1/18; H02K 15/12; C08J 9/00

(52) U.S. Cl. 310/216.137; 29/596; 521/85

(57) ABSTRACT

The invention relates to a method for producing a stator housing unit for an electric machine, wherein a stator is connected to a housing. Before connecting, at least one partial surface of the common contact surfaces is coated with a paint material comprising a material additive expanding irreversibly upon first reaching a prescribed expansion temperature. The invention further relates to a stator housing unit and a paint material having 5% to 10% weight proportion of a material additive expanding irreversibly upon first reaching a prescribed expansion temperature, 10% to 20% boron nitride, and phenolic resin.

The invention relates to a method for producing a stator housing unit for an electrical machine, wherein a stator is connected to a housing, relates to a stator housing unit and relates to a paint material.

It is generally known that electrical machines, such as for example asynchronous machines or generators, have a stator. Such a stator usually comprises laminated cores with slots for winding conductors, which are introduced during the production process of the electrical machine.

During the production process of an electrical machine, the stator is usually connected to a housing surrounding it, or is integrally joined to it. Such a housing serves, for example, for mechanical protection of the finished electrical machine, but also for better handling thereof. It is, for example, possible to provide fastening elements on the housing that facilitate later assembly of the electrical machine.

It is also known that electrical machines heat up while they are in operation as a result of electrical losses, this lost heat having to be removed from the electrical machines. Such heating up occurs in particular in the electrical winding conductors and leads to heating up of the components surrounding them, which ultimately make the thermal energy dissipate into the surroundings via an outer bounding surface of the electrical machine. A component which comprises a high proportion of the outer bounding surface of the electrical machine is its housing. This may, for example, also be provided with cooling ribs, in order to achieve a desired increased heat dissipating capability by the increase in the outer boundary surface this involves.

It is disadvantageous that, even after the stator and the housing have been joined, clearance fits necessitated by the production technology cause gaps between the stator and the housing, which adversely influence the heat transfer between the winding conductors and the outer bounding surface. Depending on the size or output of the electrical machine, the length of such a gap necessitated by the production technology is typically in the range from 0.1 mm to 2 mm, the outputs of corresponding electrical machines lying between some kW and several 100 MW.

On the basis of this prior art, it is the object of the invention to provide a method and means for producing a stator housing unit with which the thermal conductivity between the stator and the housing is improved and to provide a corresponding stator housing unit.

This object is achieved according to the invention by a method of the type stated at the beginning.

The method for producing a stator housing unit for an electrical machine is accordingly distinguished by the fact that, before connecting the stator and the housing, at least a partial surface of the common contact surfaces is coated with a paint material which comprises a material additive expanding irreversibly upon reaching a prescribed expansion temperature and that the connected stator housing unit is heated to at least the expansion temperature.

Consequently, it is advantageously possible to fill volumes between the connected stator and housing that are caused by the clearance fit necessitated by the production technology for the connecting operation with a solid expansion material of increased thermal conductivity in comparison with air. The expansion material also has the advantage that the mechanical connection between the stator and the housing is further increased by the filling of the volumes.

In a further refinement of the method according to the invention, a paint material which is based on phenolic resin is used, with the material additive mentioned at the beginning and with a further proportion of boron nitride.

This is because it has been found that boron nitride advantageously increases the thermal conductivity of a paint material based on phenolic resin. In this way, the thermal conductivity between the stator and the housing can be further increased.

A variant of the method according to the invention that proves to be particularly advantageous is one in which a paint material based on phenolic resin is used, with 5%-10% by weight of the material additive expanding irreversibly upon first reaching a prescribed expansion temperature and 10%-20% boron nitride. The figures specified for the proportions by weight respectively relate to the liquid state of the paint material.

In a further refinement of the method according to the invention, the stator is only connected to the housing after a prescribed minimum time after the coating of the stator and/or the housing.

In this way, the applied layer of paint advantageously dries before the connection is performed, and the connecting operation can be further simplified.

The object according to the invention is also achieved by a stator housing unit for an electrical machine which is characterized in that on at least a partial area of the contact area between the stator and the housing there is a paint material which comprises a material additive expanding irreversibly upon first reaching a prescribed expansion temperature.

Volumes caused by the production technology and resulting from a gap between the stator and the housing are advantageously filled with expansion material. As a result, particularly high thermal conductivity between the stator and the housing is achieved.

The object according to the invention is also achieved by a paint material based on phenolic resin, with 5% to 10% by weight of the material additive expanding irreversibly upon first reaching a prescribed expansion temperature and 10% to 20% boron nitride. The figures specified for the proportions by weight respectively relate to the liquid state of the paint material. In the dried state of the paint material based on phenolic resin and provided with the material additive, that is to say after the volatile constituents have escaped, different proportions by weight of the material additives are obtained, about 12.5 to 25% by weight of the material additive expanding irreversibly upon first reaching a prescribed expansion temperature and about 25% to 50% boron nitride.

It has been found that this composition is particularly suitable for achieving the stated object.

Suitable for example as the irreversibly expanding material additive is the product of the ‘Expancel’ type 950 DU 120 from the AKZO Nobel company. ‘Expancel’ is distinguished by the fact that an exactly measured amount of an expanding agent is enclosed in a plastic shell of just a few micrometers. When this microsphere is heated, the plastic shell softens, the expanding agent becomes gaseous and the microsphere expands irreversibly in a defined way. Other material additives with similar properties are also conceivable, including those which work on different operating principles, for example expansion caused by chemical processes.

Products from the company Momentive Performance Materials of the type BN5 or CF100, for example, have proven to be suitable as the boron nitride.

A suitable phenolic resin is, for example, the product of the type LG 9968 from the company Hexion/Bakelite.

The invention, further embodiments and further advantages are described in more detail on the basis of the exemplary embodiments that are represented in the drawings and in which:

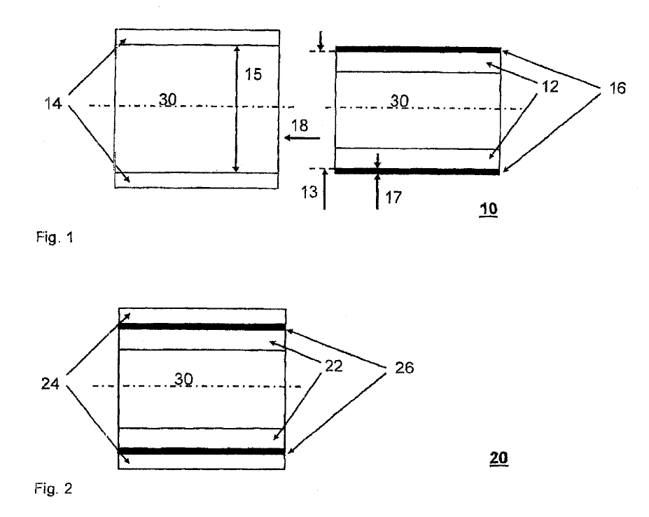

FIG. 1 shows a first overview with a separately coated first stator and first housing.

FIG. 2 shows a second overview with a connected stator housing unit.

FIG. 1 shows a first overview 10 of a separate first stator 12 and a first housing 14 of an electrical machine. Both the stator 12 and the housing 14 are indicated in an idealized form as rotationally symmetrical about an axis of rotation 30. According to the invention, electrical machines in the output range of some kW to several 100 MW are conceivable.

The stator 12 has an outside diameter 13, which is less than the inside diameter 15 of the housing, wherein the rated clearance of inside diameter 15 to outside diameter 13 lies, for example, in the range from 0.2 mm to 4 mm, resulting in gaps between the stator and the housing of 0.1 mm to 2 mm. The stator 12 is coated on its outer circumferential surface with a layer of paint 16, which has a thickness 17 and has not yet been heated to an expansion temperature, and has a thickness of, for example, 0.05 to 1 mm. The thickness 17 of the layer of paint 16 may vary due to possible unevennesses of the outer surface of the stator 12 and also tolerances in the coating operation.

Before the stator 12 and the housing 14 are connected, first the later common contact area of the stator 12 and the housing 14 should be completely or partially coated with a paint material according to the invention. The contact surface is formed by the outer circumferential surface of the stator 12 and the inner circumferential surface of the housing 14. Accordingly, before the connection is performed, at least one of the two stated surfaces that form the contact surface should be painted in the region of the later contact surface at which the thermal conductivity between the stator 12 and the housing 14 can be improved. In FIG. 1, a coated stator 12 is shown, while the housing 14 is uncoated.

Depending on the size and output of the electrical machine, the average thickness of the layer of paint lies in the range from 50 μm to 600 μm in the air-dried state, i.e. after a certain time interval after the coating operation has elapsed. Immediately after the coating operation, the thickness of the layer of paint in the so-called wet state is greater, for example by a factor of 1.5 to 4. The reason for this reduction in the thickness of the layer is that volatile constituents which evaporate during this time interval are contained in the paint material. Depending on the layer thickness, ambient temperature conditions, the composition of the paint material and other influencing factors, a suitable time interval lies in the range from 10 minutes to 2 hours.

The stator 12 and the housing 14 are subsequently pushed one into the other, which is indicated in the figure by a directional arrow 18.

FIG. 2 shows a second overview of a stator housing unit 20 with a second stator 22 and a second housing 24. The intermediate space between the second stator 22 and the second housing 24 is completely filled with a layer of paint, which has already been heated to expansion temperature after the connection has been performed. During the heating operation there was a volume expansion of the layer of paint which has filled possible air volumes. The complete filling of the intermediate space advantageously results in additional mechanical fixing of the stator and the housing to one another.

Particularly favorable properties are achieved especially by using a paint material with 5% to 10% by weight of a material additive expanding irreversibly upon first reaching a prescribed expansion temperature, 10% to 20% boron nitride and phenolic resin. The boron nitride in this case improves the thermal conductivity.

In the event that the theoretical expansion volume of the coated paint material exceeds the volume to be filled between the stator and the housing, the expansion process stops independently as a result of the associated increase in pressure, in particular in the case of the aforementioned paint material.

### LIST OF DESIGNATIONS

10 first overview of separate first stator and first housing

12 first stator

13 outside diameter of first stator

14 first housing

15 inside diameter of first housing

16 first layer of paint

17 thickness of first layer of paint

18 direction of movement when the connection is performed

20 second overview of stator housing unit

22 second stator

24 second housing

26 second layer of paint

30 axis of rotation

What is claimed is:

1. A method for producing a stator housing unit for an electrical machine, comprising:
coating at least a partial surface of common contact surfaces with a paint material which comprises a material additive expanding irreversibly upon reaching a prescribed expansion temperature;
connecting, after coating, a stator to the housing; and
heating connected stator housing unit to at least the expansion temperature.

2. The method as claimed in claim 1, wherein the paint material is based on phenolic resin with a proportion of boron nitride.

3. The method as claimed in claim 1, wherein the paint material is based on phenolic resin with 5%-10% by weight of the material additive expanding irreversibly upon first reaching a prescribed expansion temperature and 10%-20% boron nitride.

4. The method as claimed in claim 1, wherein the stator is only connected to the housing after a prescribed minimum time after the coating of the stator and/or the housing.

5. The method as claimed in claim 2, wherein the stator is only connected to the housing after a prescribed minimum time after the coating of the stator and/or the housing.

6. The method as claimed in claim 3, wherein the stator is only connected to the housing after a prescribed minimum time after the coating of the stator and/or the housing.

7. A stator housing unit for an electrical machine, comprising:
a housing; and
a stator connected to the housing at a contact area, wherein on at least a partial area of the contact area between the stator and the housing there is a paint material which comprises a material additive expanding irreversibly upon first reaching a prescribed expansion temperature.

8. A paint material based on phenolic resin with 5% to 10% by weight of a material additive expanding irreversibly upon first reaching a prescribed expansion temperature and 10% to 20% boron nitride.
